(19) United States
(12) Patent Application Publication
(10) Pub. No.: US 2016/0345339 A1
(43) Pub. Date: Nov. 24, 2016

(54) BASE STATION, TERMINAL STATION, AND WIRELESS COMMUNICATION SYSTEM

(71) Applicant: MITSUBISHI ELECTRIC CORPORATION, Tokyo (JP)

(72) Inventor: Toshinori HORI, Tokyo (JP)

(73) Assignee: Mitsubishi Electric Corporation, Tokyo (JP)

(21) Appl. No.: 15/108,534

(22) PCT Filed: May 9, 2014
(86) PCT No.: PCT/JP2014/062490

§ 371 Date: Jun. 27, 2016

(30) Foreign Application Priority Data
Jan. 7, 2014 (JP) 2014-000988

(51) Int. Cl. H04W 72/08; H04W 48/16; H04W 72/04; H04W 24/10

(52) U.S. Cl. CPC H04W 72/085; H04W 24/10; H04W 48/16; H04W 72/0453; H04W 84/12

(57) ABSTRACT

A base station in a wireless includes: a surrounding AP measurement unit that instructs terminal stations to execute a base station search operation and searches for another base station; a channel quality evaluation unit that evaluates available wireless channels on the basis of the result of the base station search by the surrounding AP measurement unit and the result of the base station search by each of the accommodated terminal stations; a channel selection unit that selects a wireless channel for use on the basis of the result of the evaluation; and a channel setting unit that instructs the terminal stations to switch to a wireless channel selected by the channel selection unit for communication and switches a wireless channel for its own use to the wireless channel selected by the channel selection unit.

### FIELD

The present invention relates to a base station and a terminal station of a wireless LAN system and a wireless communication system.

### BACKGROUND

Of the wireless LAN systems specified in the IEEE802.11 standards, a wireless LAN system that uses the 2.4 GHz band is specified to have 13 channels spaced 5 MHz apart (see Non Patent Literature 1). A wireless LAN base station (AP: Access Point) that operates in an infrastructure mode operates using a fixed channel set by the user and operates with a wireless LAN terminal station (STA: Station) connected to the AP as a wireless LAN system.

CSMA/CA (Carrier Sense Multiple Access/Collision Avoid) is employed as an access method for wireless LAN systems in the IEEE802.11 standards. CSMA/CA in the IEEE802.11 standards performs carrier sensing for a certain time period before transmitting and, if no carrier is detected, performs the transmission. If a carrier is detected, a random waiting time is set and held, during which the transmission is put on standby. Then, when the disappearance of a carrier is detected, the carrier sensing is performed for the random waiting time being held. If a carrier is detected again during the random waiting time, the present random waiting time is held and the transmission is kept on standby until the carrier disappears. The operations described above are repeated until the transmission is completed.

As described above, the wireless LAN system using the 2.4 GHz band has channels allocated at 5 MHz spacing, and the user can decide which channel to use at the discretion of the user. The channels, however, have a communication bandwidth of approximately 22 MHz; thus, if a channel is not separated from that of an existing wireless LAN system by five channels or more, interference between the systems will result.

Here, a problem with a case in which a channel for use is set on the same channel as an existing system (another wireless LAN system in the surroundings) and a problem with a case in which a channel for use is set to be separated from that of an existing system by one channel or more and less than five channels will be described.

The problem with the case in which a channel for use is set on the same channel as an existing system is band sharing with the existing system. A signal from the existing system is indistinguishable from the newly set system immediately after the reception processing even when the field intensity from the existing system is low, and thus transmission has to be put on standby.

The problem with the case in which a channel for use is set to be separated from that of an existing system by one channel or more and less than five channels is that a reduction in SIR (Signal Interference Ratio) due to overlapping of the communication bands causes data error during demodulation. A high field intensity from the existing system of course results in a transmission standby time due to CSMA/CA.

Patent Literature 1 describes a technique for solving the interference problems as described above, specifically a technique in which an AP calculates the degree of influence by interference (the degree of influence by another channel) for each candidate channel and selects a channel with the lowest degree of influence by interference.

### CITATION LIST

### Patent Literature

Patent Literature 1: Japanese Patent Application Laid-Open No. 2008-078698

### Non Patent Literature

Non Patent Literature 1: IEEE802.11 Standard 2012 “Part 11: Wireless LAN Medium Access Control (MAC) and Physical Layer (PHY) Specifications”

### SUMMARY

### Technical Problem

The technique described in Patent Literature 1 is to select a channel for use with consideration given to the quality of each channel (the degree of influence by interference) at an AP; however, selecting a channel with consideration given only to the state at an AP may hinder the selection of an optimal channel because the interference problem of a wireless LAN system occurs both at an AP and an STA. Additionally, different communication devices (an AP and an STA) have different amounts of interference from an existing system; thus, in order to select an optimal channel for use for the entire wireless LAN system, it is necessary to set a channel with consideration given to a communication device most subject to interference by an existing system.

The present invention has been achieved in view of the above, and an object of the present invention is to obtain a base station, a terminal station, and a wireless communication system that select as a channel for use a wireless channel subject to low interference from another system.

### Solution to Problem

In order to solve the above problems and achieve the object, an aspect of the present invention is a base station in a wireless LAN system, including: a base station search unit that, when a predetermined condition is satisfied, instructs accommodated terminal stations to execute a base station search operation and searches for another base station; a channel quality evaluation unit that evaluates quality of each of available wireless channels on a basis of a first search result, which is a result of a base station search by the base station search unit and a second search result, which is a result of a base station search by each of the accommodated terminal stations; a channel selection unit that selects a wireless channel for use in communication with the accommodated terminal stations on a basis of a result of an evaluation by the channel quality evaluation unit; and a channel switching unit that instructs the accommodated terminal stations to switch to a wireless channel selected by the channel selection unit for communication and switches a wireless channel for use by the base station to the wireless channel selected by the channel selection unit.

### Advantageous Effects of Invention

The present invention produces an effect of enabling a base station to select as a channel for use a wireless channel subject to low interference from another system, with consideration also given to the quality of communication at each terminal station in a system.

### BRIEF DESCRIPTION OF DRAWINGS

FIG. 1 is a diagram illustrating an example configuration of a wireless communication system including a base station and terminal stations according to the present invention.

FIG. 2 is a diagram illustrating an exemplary configuration of the base station (AP).

FIG. 3 is a diagram illustrating an exemplary configuration of the terminal station (STA).

FIG. 4 is a sequence diagram illustrating an exemplary operation to change a channel for use.

FIG. 5 is a diagram illustrating example information retained in a beacon retention unit of the AP.

FIG. 6 is a diagram illustrating example information retained in a beacon retention unit of the STA.

FIG. 7 is a diagram illustrating example information retained in the beacon retention unit of the STA.

FIG. 8 is a diagram illustrating an example information table to be created by an unused-channel detection unit.

FIG. 9 is a diagram illustrating an example information table to be created by a reception power estimation unit and a carrier sensing estimation unit.

FIG. 10 is a diagram illustrating an example information table to be created by the reception power estimation unit and the carrier sensing estimation unit.

FIG. 11 is a diagram illustrating an example information table to be created by an SINR calculation unit.

### DESCRIPTION OF EMBODIMENTS

An exemplary embodiment of a base station, a terminal station, and a wireless communication system according to the present invention will now be described in detail with reference to the drawings. The present invention is not limited to the embodiment.

### Embodiment

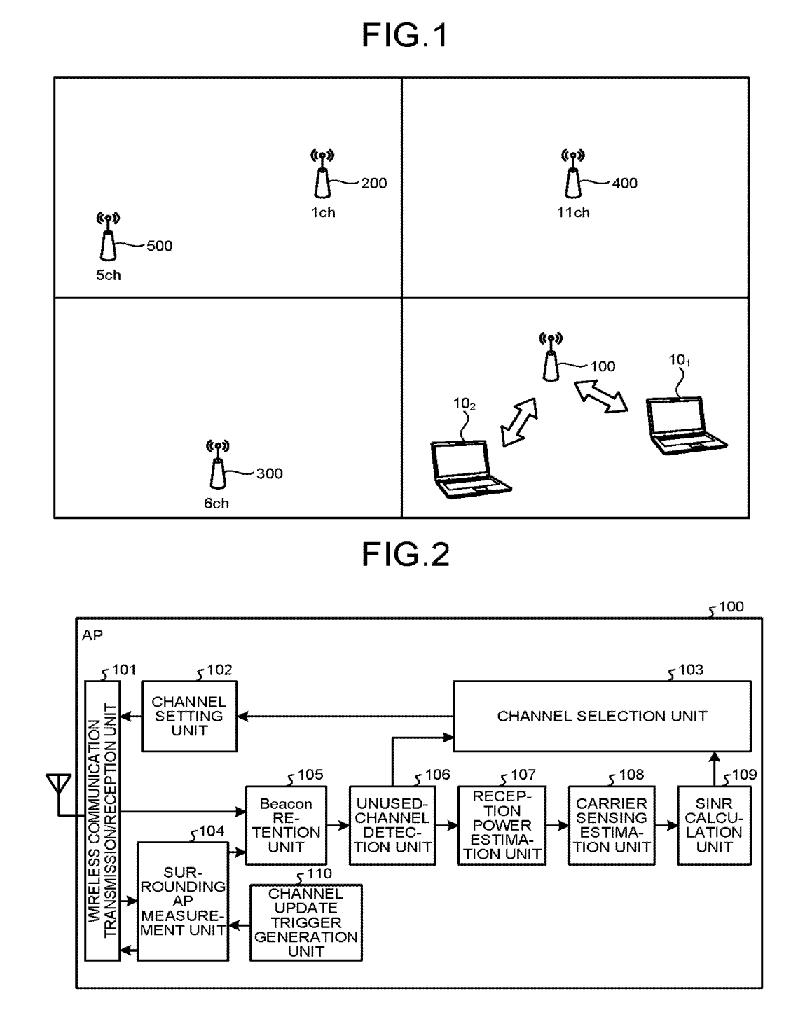

FIG. 1 is a diagram illustrating an example configuration of a wireless LAN system including a base station and terminal stations according to the present invention. FIG. 1 also illustrates an example positional relationship between the wireless LAN system as the wireless communication system according to the present invention and other wireless LAN systems. A base station (hereinafter referred to as AP (Access Point)) 100 and terminal stations (hereinafter referred to as STA (Station)) 10₁ and 10₂ correspond to the base station and the terminal stations of the present invention. APs 200, 300, 400, and 500 are base stations (APs) of the other wireless LAN systems. The illustration of terminal stations (STA) in the other wireless LAN systems, in other words, STAs connected to the APs 200, 300, 400, and 500, is omitted. The APs 100, 200, 300, 400, and 500 operate in a 2.4 GHz band, and each of them communicates with the STAs using one channel selected from 13 available wireless channels. The configuration of the wireless channels (frequency and channel spacing) is in accordance with the specifications in Non Patent Literature 1.

In the present embodiment, it is assumed that the AP 200 is already operated using a 1ch (a channel 1), the AP 300 using a 6ch (a channel 6), the AP 400 using a 11ch (a channel 11), and the AP 500 using a 5ch (a channel 5) in, for example, a building, in which the AP 100 is newly added to be operated. The AP 100 is to be connected to the STA 10₁ and the STA 10₂.

The configuration of the AP 100 will now be described. FIG. 2 is a diagram illustrating an exemplary configuration of the AP 100.

As illustrated in FIG. 2, the AP 100 includes a wireless communication transmission/reception unit 101, a channel setting unit 102, a channel selection unit 103, a surrounding AP measurement unit 104, a beacon retention unit 105, an unused-channel detection unit 106, a reception power estimation unit 107, a carrier sensing estimation unit 108, an SINR calculation unit 109, and a channel update trigger generation unit 110.

In the AP 100, the wireless communication transmission/reception unit 101 transmits and receives wireless signals.

The channel setting unit 102, which serves as a channel switching unit, sets a wireless channel with which the wireless communication transmission/reception unit 101 performs the transmission and reception and instructs an STA being connected to the AP of interest (the AP 100) to use the identical wireless channel with the one with which the wireless communication transmission/reception unit 101 performs the transmission and reception.

The channel selection unit 103 selects a wireless channel with which the wireless communication transmission/reception unit 101 performs the transmission and reception, in other words, a channel for use in the wireless LAN system of interest.

The surrounding AP measurement unit 104, which serves as a base station search unit, instructs each STA being connected to the AP of interest to execute an AP search operation and searches for an AP present in the surroundings of the AP of interest when a channel update trigger, which provides an instruction to start an operation to select a channel for use, is generated, and collects beacon information.

The beacon retention unit 105 receives and retains the beacon information collected by the surrounding AP measurement unit 104, the beacon information collected during the AP search executed by each STA being connected to the AP of interest, and transmission power information of each STA.

The unused-channel detection unit 106 detects an unused channel that is subject to no interference from another wireless LAN system and the like on the basis of the beacon information retained in the beacon retention unit 105.

The reception power estimation unit 107 estimates reception power (interference power received from another wireless LAN system) at each of the 13 available wireless channels if no unused channel is present.

The carrier sensing estimation unit 108 estimates whether the carrier sensing detects a carrier (whether transmission standby is caused by the carrier detection) for each of the 13 available wireless channels.

The SINR calculation unit 109 calculates an SINR (Signal-to-Interference plus Noise power Ratio) for each of the 13 available wireless channels.

The channel update trigger generation unit 110 monitors whether a condition to execute an operation to update (re-select) a channel for use in communication with the STAs is satisfied and, if the condition is satisfied, outputs a channel update trigger to the surrounding AP measurement unit 104 to start the operation to select a wireless channel. The channel update trigger generation unit 110 may, for example, include an internal timer and be configured to determine that the execution condition (the condition to execute an operation to select a wireless channel) is satisfied every time the internal timer expires (every time a certain time elapses); alternatively, it may be configured to determine that the execution condition is satisfied when the user operates to provide an instruction to execute the operation to select a wireless channel. Alternatively, the channel update trigger generation unit 110 may be configured to determine that the execution condition is satisfied when a request is received from an STA; alternatively, it may be configured to determine that the execution condition is satisfied when a degradation in quality of communication with an STA is detected. The channel update trigger generation unit 110 may be configured in other ways than those described above.

Note that the unused-channel detection unit 106, the reception power estimation unit 107, the carrier sensing estimation unit 108, and the SINR calculation unit 109 constitute a channel quality evaluation unit.

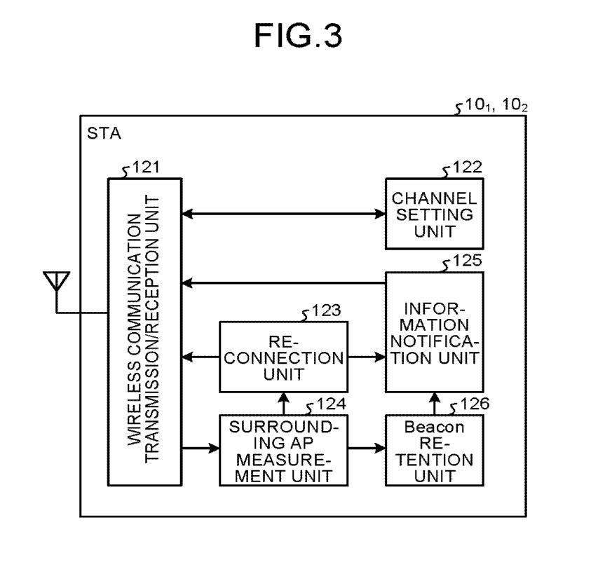

The configurations of the STAs 10₁ and 10₂ to be connected to the AP 100 will now be described. The configurations of the STAs 10₁ and 10₂ are the same. FIG. 3 is a diagram illustrating an exemplary configuration of the STAs 10₁ and 10₂.

As illustrated in FIG. 3, the STAs 10₁ and 10₂ each include a wireless communication transmission/reception unit 121, a channel setting unit 122, a reconnection unit 123, a surrounding AP measurement unit 124, an information notification unit 125, and a beacon retention unit 126.

In the STAs 10₁ and 10₂, the wireless communication transmission/reception unit 121 transmits and receives wireless signals.

Upon receipt of a notification of a wireless channel selected by the AP 100, the channel setting unit 122, which serves as a channel switching unit, changes the setting of the wireless communication transmission/reception unit 121 to perform the transmission and reception using the indicated wireless channel.

The reconnection unit 123 executes processing to reconnect with the AP 100 after the change of a channel for use in communication with the AP 100.

The surrounding AP measurement unit 124, which serves as a base station search unit, searches for an AP present in the surroundings of the STA of interest and collects beacon information in accordance with the instruction from the AP 100.

The information notification unit 125 notifies the AP 100 of the beacon information collected by the surrounding AP measurement unit 124 and information on transmission power of the STA of interest in its transmission of a wireless signal.

The beacon retention unit 126 receives and retains the beacon information collected by the surrounding AP measurement unit 124.

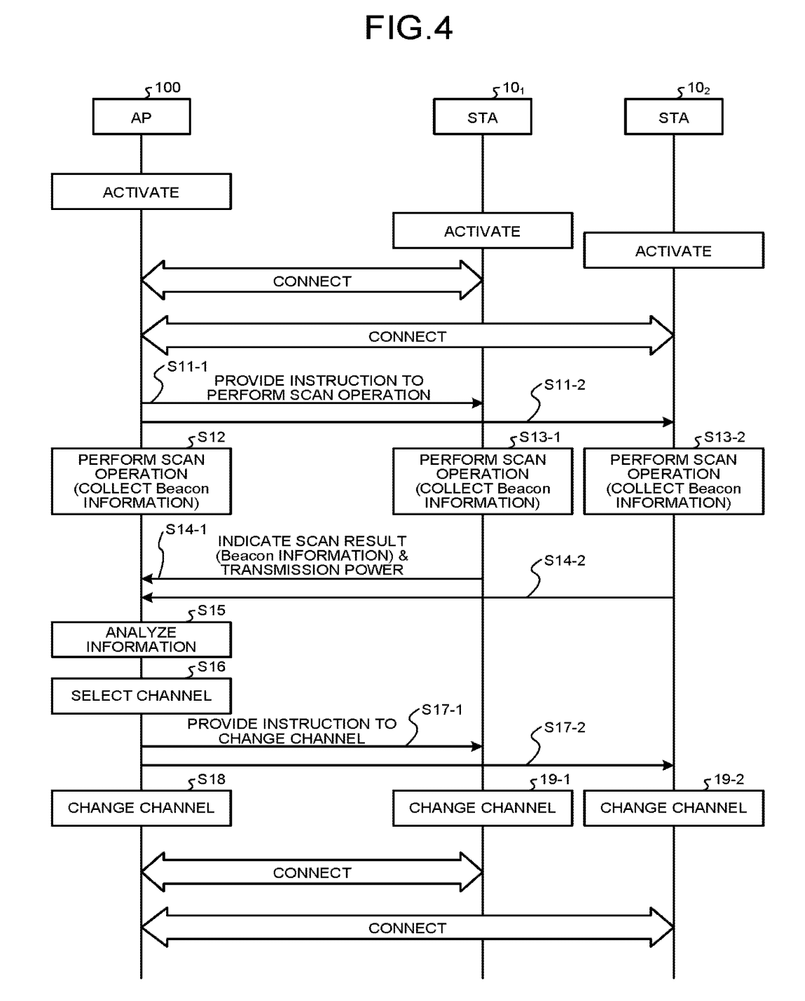

Operations of the AP 100, the STA 10₁, and the STA 10₂ in the wireless communication system according to the present embodiment, specifically their exemplary operations to change a channel for use, will now be described. In the present embodiment, operations from the activation of the AP 100 until the completion of changing a channel will be described as an example with reference to FIG. 4. FIG. 4 is a sequence diagram illustrating an exemplary operation to change a channel for use.

The power to the AP 100 is turned on to activate the AP 100. A default value (for example, the 1ch) is used for the initial channel at this point in time. Then, the STA 10₁ and the STA 10₂ are activated and each connected to the AP 100.

In the AP 100, the channel update trigger generation unit 110 monitors whether a condition to execute the operation to update (set again) the channel for use is satisfied. If the condition is satisfied, a channel update trigger is output to the surrounding AP measurement unit 104 to start the operation to change a channel for use. A channel update trigger is output on the basis of a condition such as, for example, when an internal timer of the AP 100 expires, when the user operates to request to change a channel for use, or when a reduction in throughput or an increase in retransmission rate is a value equal to or greater than a threshold.

Upon generation of a channel update trigger, the surrounding AP measurement unit 104 in the AP 100 instructs the STAs 10₁ and 10₂ to perform a scan operation (steps S11-1 and S11-2) and also performs a scan operation itself (step S12). Here, the scan operation is an operation by the devices (the AP and the STAs) to search the surroundings for an AP. In the scan operation, the reception operation is performed using each of the available wireless channels (the 13 wireless channels in the present embodiment) for a certain time period to receive a signal that includes beacon information and is transmitted by an AP at a certain cycle (hereinafter referred to as a beacon signal), and switching is performed among the wireless channels after each reception operation to collect the beacon information. The beacon information contains information such as a MAC address and an SSID (Service Set Identifier) of a source AP. The reception operation is performed for each wireless channel for a time period at least longer than a transmission cycle of beacon signals.

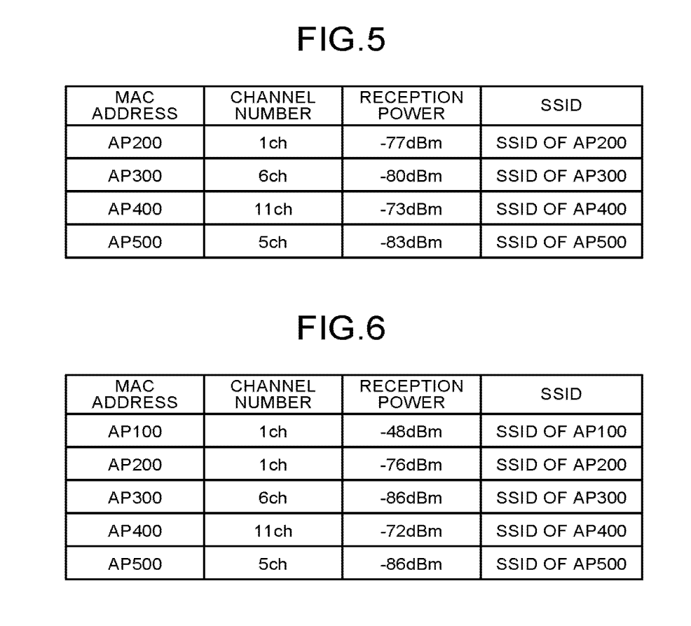

When the scan operation is finished, the surrounding AP measurement unit 104 in the AP 100 stores the collected beacon information in the beacon retention unit 105. The beacon retention unit 105 retains the received beacon information as sorted by AP as illustrated in FIG. 5. As illustrated in FIG. 5, the information to be retained includes the MAC address, a channel number, the reception power, and the SSID. Other information may also be retained. Here, the MAC address is the MAC address of an AP found in the scan operation and the channel number is a number for a wireless channel with which a beacon signal is received and represents the wireless channel being used by an AP from which the beacon signal is received. The reception power is the reception power of a beacon signal and the SSID is the SSID of an AP found in the scan operation. Information except the reception power is extracted from the beacon information.

When the scan operation is completed, the AP 100 restarts the operation using the original wireless channel (here, it is the 1ch).

In the meantime, upon the receipt of the instruction to perform the scan operation, the surrounding AP measurement unit 124 in each of the STAs 10₁ and 10₂ performs the scan operation in a similar manner to the surrounding AP measurement unit 104 in the AP 100 to receive a beacon signal transmitted by an AP in the surroundings in each of the 13 available wireless channels and collect the beacon information (steps S13-1 and S13-2).

When the scan operation is finished, the surrounding AP measurement unit 124 in each of the STAs 10₁ and 10₂ stores the collected beacon information in the beacon retention unit 126. The reconnection unit 123 reconnects to the AP 100 using the original wireless channel (here, it is the 1ch) to restart the operation. Upon storing of the beacon information, the beacon retention unit 126 notifies the information notification unit 125 of the beacon information, and the information notification unit 125 notifies the AP 100 of the beacon information received from the beacon retention unit 126. The transmission power of a signal is also indicated (steps S14-1 and S14-2).

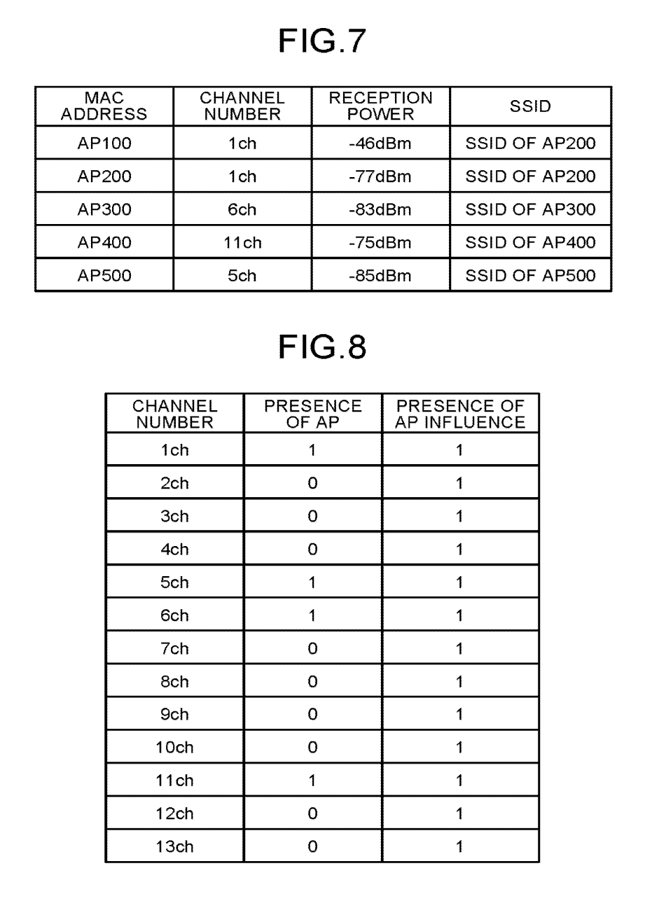

The information stored in the beacon retention unit 126 of the STA 10₁ is illustrated in FIG. 6 and the information stored in the beacon retention unit 126 of the STA 10₂2 is illustrated in FIG. 7. As illustrated in FIGS. 6 and 7, the beacon retention unit 126 in each of the STA 10₁ and the STA 10₂ stores the MAC address, the channel number, the reception power, and the SSID, in a similar manner to the beacon retention unit 105 in the AP 100.

Upon reception of the notification of the beacon information and the transmission power information from the STAs (the STA 10₁ and the STA 10₂), the AP 100 stores the indicated information in the beacon retention unit 105 and retains it.

When the AP 100 is notified of the beacon information and the transmission power by all the STAs being connected to the AP 100 (the STA 10₁ and the STA 10₂ here), the AP 100 analyzes the information retained in the beacon retention unit 105, that is, the beacon information and the transmission power indicated by each of the STAs and the beacon information collected by executing step S12 (step S15), and selects (step S16) a channel for use.

<Information Analysis Operation>

The information analysis operation in step S15 described above will now be described in detail. The information analysis operation is performed by the unused-channel detection unit 106, the reception power estimation unit 107, the carrier sensing estimation unit 108, and the SINR calculation unit 109, which constitute the channel quality evaluation unit.

In the AP 100, an information table (a table including the information on the channel number, presence of AP, and presence of AP influence) having a configuration illustrated in FIG. 8 is created from the information retained in the beacon retention unit 105. The information retained in the beacon retention unit 105 includes the information illustrated in FIGS. 5, 6, and 7 and information on the transmission power (the power of a signal transmitted by each STA to the AP 100). The “presence of AP” indicates whether or not an AP is present that is using a wireless channel having a corresponding channel number (whether or not the wireless channel is in use); “1” is provided if such an AP is present, and “0” is provided if no such AP is present. In the example in FIG. 8, the wireless channels of the 1ch, the 5ch, the 6ch, and the 11ch are in use. The “presence of AP influence” indicates whether or not a corresponding wireless channel is influenced by (interfered with) an AP in the surroundings; “1” is provided if there is an influence, and “0” is provided if there is no influence.

That is, the unused-channel detection unit 106 analyzes the information retained in the beacon retention unit 105 and sets “1” in a field under the “presence of AP” corresponding to the channel number of a wireless channel with which an AP is detected and sets “0” in a field under the “presence of AP” corresponding to the channel number of a wireless channel with which no AP is detected. FIGS. 5, 6, and 7 indicate that the AP 100, the STA 10₁, and the STA 10₂ all detect APs with the 1ch, the 5ch, the 6ch, and the 11ch. Hence, “1” is set in the fields corresponding to these channels under the “presence of AP,” and “0” is set in the other fields under the “presence of AP”. Additionally, “1” is set under the “presence of AP influence” in the fields for four channels before and after a wireless channel with which an AP is detected, and “0” is set in the other fields. The reason for setting “1” for four channels before and after a wireless channel with which an AP is detected (for treating these channels as influenced by the AP) is that each of the 13 available wireless channels is placed such that its band partially overlaps with those of the four adjacent wireless channels. As described above, APs are detected with the 1ch, the 5ch, the 6ch, and the 11ch, and the intervals between these wireless channels with which the APs are detected each include four channels or less; thus, “1” is set in the fields for all the channels under the “presence of AP influence”. A field in which “0” is set under the “presence of AP influence” represents a clear channel (an unused channel) subject to no influence (a small enough influence) from the communication with another wireless LAN, and hence such an unused channel will be used if there is one. If there are any unused channels, the channel selection unit 103 selects a channel for use from the unused channels.

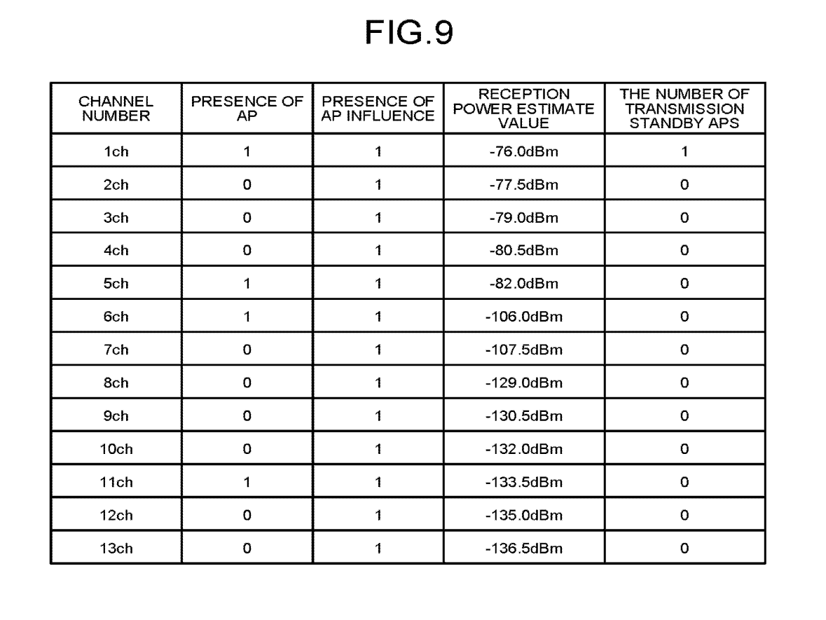

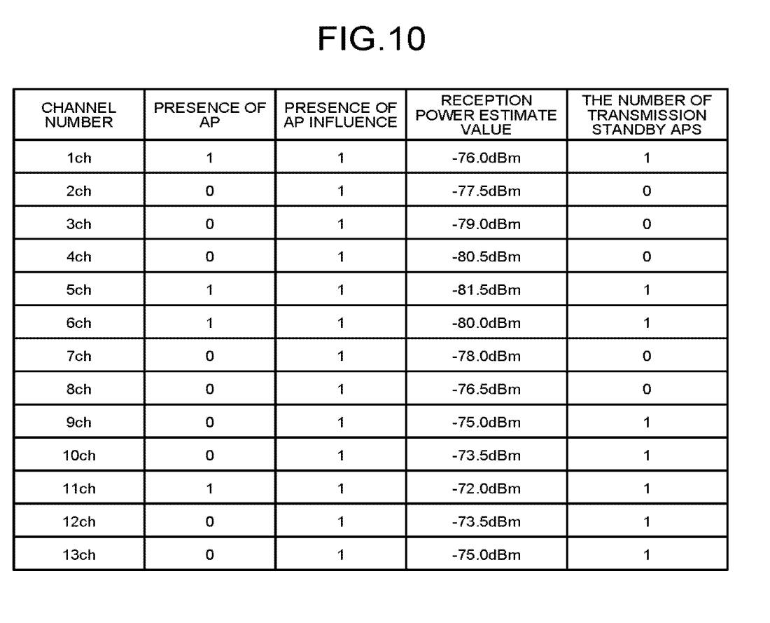

In the case of FIG. 8, it is determined that there is no unused channel because all the fields under the “presence of AP influence” indicate “1”. If there is no unused channel, the reception power estimation unit 107 and the carrier sensing estimation unit 108 analyze the information retained in the beacon retention unit 105 and create an information table (a table including the channel number, the presence of AP, the presence of AP influence, a reception power estimate value, and the number of transmission standby APs) having a configuration illustrated in FIGS. 9 and 10 by performing operations such as estimation of reception power from another wireless LAN system for each of the wireless channels. The information tables illustrated in FIGS. 9 and 10 include the information table illustrated in FIG. 8 (that is, the information table created by the unused-channel detection unit 106), with the reception power estimate value and the number of transmission standby APs added to it. An example information table being created is illustrated in FIG. 9 and an example information table that is completed is illustrated in FIG. 10. The “reception power estimate value” indicates an estimate value of the reception power with a wireless channel having the corresponding channel number and “the number of transmission standby APs” indicates the number of APs that may cause transmission standby (carrier detection by carrier sensing) in any of the devices in the wireless LAN system of interest (the AP 100, the STA 10₁, and STA 10₂), in other words, the number of APs that influence the communication of the wireless LAN system of interest significantly enough to cause transmission standby. It is desirable that the number of transmission standby APs be small and an increase of this number indicates an increase in probability of the occurrence of the transmission standby and a reduction in communication efficiency (the throughput). Note that information simply indicative of whether or not an AP that may cause transmission standby may be retained in lieu of the number of transmission standby APs. The “reception power estimate value” is calculated by the reception power estimation unit 107 and “the number of transmission standby APs” is calculated by the carrier sensing estimation unit 108.

[Operation to Calculate a Reception Power Estimate Value]

An operation by the reception power estimation unit 107 to calculate a reception power estimate value will now be described in detail. The operation to calculate a reception power estimate value to be described below is based on a case in which another wireless LAN system performs transmission using the 1ch.

The reception power estimation unit 107 refers to the information tables in FIGS. 5 to 7 and inputs, as a reception power estimate value for the 1ch, the reception power from the AP 200 present in the 1ch (the AP 200 using the 1ch) in the STA 10₁ (−76 dBm, see FIG. 6), which is a high reception power. Then, the reception power estimate value for a 2ch (a channel 2) is calculated from the reception power of the AP 200 present in the 1ch because there is no AP in the 2ch. In the present embodiment, the reception power estimate value is calculated on the basis of the assumption that the reception power of a channel is half of that of a channel that is two channels away and in which an AP is present, that is, it is reduced by 3 dB, and that the reception power of a channel that is one channel away is reduced by 1.5 dB and the calculated value (−77.5 dBm) is the reception power estimate value for the 2ch (and is written in the information table). The reduction amount of a reception power estimate value for a channel that is one channel away may be changed in accordance with the reception performance of the AP 100, the STA 10₁, and the STA 10₂. Then, the reception power estimate values for a 3ch (a channel 3), a 4ch (a channel 4), and the 5ch are calculated in a similar manner. The 6ch, which is five channels away, has no communication band overlap; thus, in view of the spectrum specification in Non Patent Literature 1, a value obtained by subtracting 30 dB from the reception power estimate value of the 1ch is the reception power estimate value of the 6ch. The reception power estimate value for a 7ch (a channel 7) is a value obtained by subtracting 1.5 dB from the reception power estimate value of the 6ch and the reception power estimate value for a 8ch (a channel 8), which is seven channels away, is a value obtained by subtracting 50 dB from the reception power estimate value of the 1ch. The reception power estimate values for a 9ch (a channel 9), a 10ch (a channel 10), the 11ch, a 12ch (a channel 12), and a 13ch (a channel 13) are values obtained by subtracting 1.5 dB from the reception power estimate value for the 8ch and then from the result of the subtraction after each subtraction. The reception power estimate value for each channel is obtained in the manner described above.

[Operation to Calculate the Number of Transmission Standby APs]

An operation by the carrier sensing estimation unit 108 to calculate the number of transmission standby APs will now be described in detail. The operation to calculate the number of transmission standby APs to be described below is based on a case in which another wireless LAN system performs transmission using the 1ch.

When the calculation of the reception power estimate value by the reception power estimation unit 107 is finished, the carrier sensing estimation unit 108 then obtains a channel with which transmission standby is caused when the AP 200, which is using the 1ch, performs transmission and writes the result in a field under “the number of transmission standby APs”. Here, the AP 100, the STA 10₁, and the STA 10₂ have different carrier sensing thresholds in accordance with the transmission power of these devices. Non Patent Literature 1 specifies that the reception power that needs to be detected by the carrier sensing be −80 dBm if the transmission power is more than 100 mW, −76 dBm if the transmission power is more than 50 mW and not more than 100 mW, −70 dBm if the transmission power is not more than 50 mW. In the present embodiment, it is assumed that all the devices perform transmission at 100 mW for simplification. Hence, a transmission waiting time is caused for a channel with which a carrier of −76 dBm or more is received. As described above, the maximum of the reception power estimate values in the case of the AP 200 performing transmission is −76 dBm with the 1ch. Hence, the reception power estimate value is equal to or greater than the carrier sensing threshold (−76 dBm) with the 1ch only, that is, when the AP 200 performs the transmission, the channel with which transmission standby is caused is the 1ch only. Thus, one is added to the number of transmission standby APs for the 1ch, with no change to the numbers of transmission standby APs for the other channels. This results in the information table illustrated in FIG. 9.

The reception power estimation unit 107 and the carrier sensing estimation unit 108 execute the processing described above (the [operation to calculate a reception power estimate value], and the [operation to calculate the number of transmission standby APs]) sequentially for the 5ch, the 6ch, and the 11ch (channels having a field under the “presence of AP” in which “1” is set) and update the information table as illustrated in FIG. 9. Specifically, the “reception power estimate value” and the “the number of transmission standby APs” are updated for each channel. If, however, a value that has been input in a field is greater than a reception power estimate value to be input, it is not overwritten during the update. When the processing for the 5ch, the 6ch, and the 11ch is completed, the information table illustrated in FIG. 10 is obtained.

By creating the information table illustrated in FIG. 10 in this manner, the interference power on an AP or an STA that is to be most influenced by another system can be obtained for each of the available wireless channels.

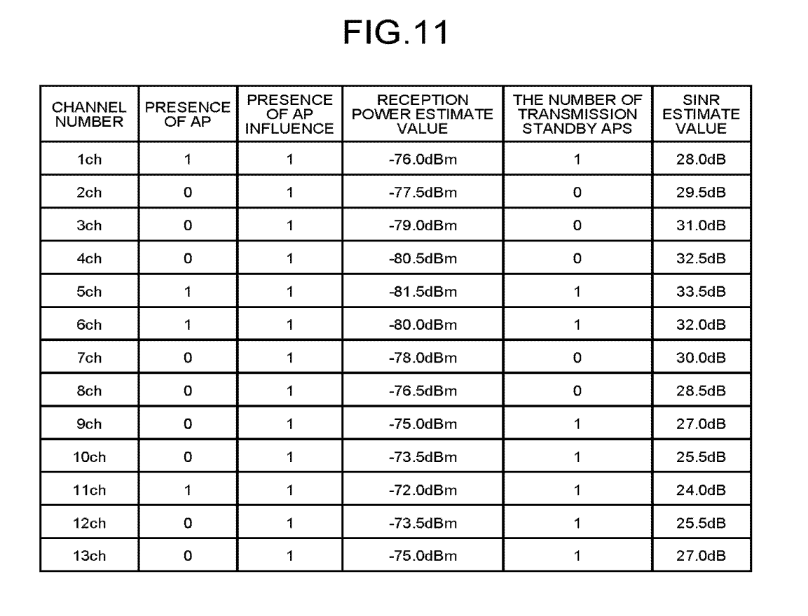

When the processing by the reception power estimation unit 107 is completed and the information table illustrated in FIG. 10 is obtained, the SINR calculation unit 109 calculates the SINR for each of the available wireless channels to create an information table having a configuration illustrated in FIG. 11. The information table illustrated in FIG. 11 includes the information table illustrated in FIG. 10 (the information table created by the unused-channel detection unit 106, the reception power estimation unit 107, and the carrier sensing estimation unit 108), with an SINR estimate value added to it.

It is assumed that the transmission power of the AP 100, the STA 10₁, and the STA 10₂ is 100 mW. It is also assumed that the reception signal power at the AP 100 from an STA is the same as the reception signal power at the STA from the AP 100 (which is the reception power corresponding to the AP 100 among the reception power indicated as the beacon information). For example, it is assumed that the reception power at the AP 100 of a signal transmitted by the STA 10₁ at 100 mW has the same value as the reception power at the STA 10₁ of a signal transmitted by the AP 100 at 100 mW. If, however, the power of a signal received by the AP 100 has a different value from the power of a signal received by the STA, the SINR calculation unit 109 calculates the SINR with consideration given to the difference.

In the case of, for example, the 1ch, the SINR estimate value is the difference between the STA 10₁, which is influenced by another wireless LAN system the most, and the AP 200; in this case, the SINR estimate value is the difference between the reception power at the STA 10₁ from the AP 100 (−48 dBm, see FIG. 6) and that from the AP 200 (−76 dBm, see FIG. 6), which is, 28 dB. The SINR estimate value is calculated for each channel in a similar manner to the reception power estimate value by the reception power estimation unit 107. That is, the SINR for the 2ch, the 3ch, and the like with no AP present is obtained with consideration given to the assumption that the reception power of a channel is half of that of a channel that is two channels away and in which an AP is present (it is reduced by 3 dB). This results in the information table illustrated in FIG. 11.

When the SINR calculation unit 109 has calculated the SINR estimate values and the information table illustrated in FIG. 11 is completed, the information analysis processing in step S15 illustrated in FIG. 4 is finished.

In step S16 illustrated in FIG. 4, the channel selection unit 103 selects, as a channel for use, a wireless channel having the maximum “SINR estimate value” from wireless channels having “0” under “the number of transmission standby APs” and SINR estimate values equal to or greater than a predetermined threshold (a threshold for guaranteeing a certain level of communication quality). This enables the channel selection unit 103 in the AP 100 in the wireless LAN system of the AP 100 to select a wireless channel with which no standby time due to the carrier sensing is caused and with which communication quality of a certain level or greater can be guaranteed for the communication with the STA 10₁ and the STA 10₂, which are connected to the AP 100.

If there is no wireless channel that satisfies the conditions described above (a wireless channel having the number of transmission standby APs=0 and an SINR estimate value equal to or greater than a threshold), the channel selection unit 103 selects a channel having the maximum reception power estimate value. This is to allow the access method by CSMA/CA to function normally such that a reduction in throughput is suppressed by selecting the identical channel with a channel with which the reception power is high if no favorable channel exists.

Alternatively, a channel may be selected by a method in which, for example, the user registers an SSID in the channel selection unit 103 in advance, and, if there is no wireless channel that satisfies the conditions described above (a wireless channel having the number of transmission standby APs=0 and an SINR estimate value equal to or greater than a threshold), the channel selection unit 103 avoids a channel being used by another AP having the registered SSID (another wireless LAN system) when selecting a channel, such that priority is given to the throughput of the system of interest, or a channel may be selected by a method in which the identical channel with the channel being used by the other AP having the SSID is selected such that the throughput of the other system is maintained. The SSID of another AP that influences the system of interest is registered in the channel selection unit 103.

With reference back to FIG. 4, upon completion of the selection of a channel for use (step S16), the AP 100 provides the STA 10₁ and the STA 10₂ with an instruction to change to the selected wireless channel (step S17-1 and S17-2). The instruction to the STA 10₁ and the STA 10₂ may be provided individually on a one-by-one basis or may be broadcast. In the case of broadcasting, information on the replacing wireless channel may be included in, for example, beacon information for transmission. In this case, it is not clear to the AP 100 whether the STA 10₁ and the STA 10₂ have been able to receive the beacon information (information on the replacing wireless channel); thus, the beacon information including the information on the replacing wireless channel may be transmitted more than once. After the provision of the instruction to change the channel for use, the AP 100 changes the channel for its own use to the wireless channel selected in step S16 at a predetermined timing (step S18).

The processing in steps S17-1 and S17-2 and S18 described above is performed by the channel setting unit 102. If change of a channel is not necessary (if the wireless channel used before the start of the scan operation is optimal), the channel setting unit 102 does not execute the processing in steps S17-1 and S17-2 and S18.

On receipt of the instruction from the AP 100 to change the channel for use, the channel setting unit 122 in each of the STA 10₁ and the STA 10₂ changes the setting for using the specified wireless channel (steps S19-1 and S19-2), and the reconnection unit 123 reconnects to the AP 100 using the replacing wireless channel.

In the case in which the instruction for each of the STAs to change the channel for use is provided by transmitting the beacon information including information on a replacing wireless channel, the AP 100 may include, for example, information on the timing to change the wireless channel (hereinafter referred to as channel change timing information) in the beacon information in addition to the information on the replacing wireless channel and transmit the beacon information such that the device itself (the AP 100) and each of the STAs (the STA 10₁ and the STA 10₂) switch the channels for use at the same timing. The channel change timing information may be, for example, the number of times a beacon signal is to be transmitted before the wireless channel is changed. That is, the beacon information including the remaining number of times the channel change timing information is to be transmitted (=the number of times the instruction is to be provided) is transmitted, and each of the devices (the AP 100, the STA 10₁, and the STA 10₂) starts the changing operation when the remaining number of times the signal is to be transmitted is zero.

As described above, the AP 100 in the wireless communication system according to the present embodiment provides each of the STAs in the system of interest with an instruction to perform the scan operation on APs at a predetermined timing, collects the scan result (beacon information) from each of the STAs, evaluates the quality of each of the available wireless channels on the basis of the collected beacon information and beacon information it obtained by performing a scan, and selects a channel for use on the basis of the result of the evaluation. This allows the selection of a channel with consideration given to the communication quality at each of the STAs in the system, thereby enabling an improvement in communication quality for the entire system. Additionally, the selection of a wireless channel with which no standby time due to the carrier sensing is caused enables a throughput reduction to be inhibited and the use efficiency of a band to be improved.

### INDUSTRIAL APPLICABILITY

As described above, a base station, a terminal station, and a wireless communication system according to the present invention are useful for a communication system configured such that the base station and the terminal station perform communication using in a fixed manner a wireless channel selected from a plurality of wireless channels.

### REFERENCE SIGNS LIST

10₁ and 10₂ terminal station (STA), 100 base station (AP), 101 and 121 wireless communication transmission/reception unit, 102 and 122 channel setting unit, 103 channel selection unit, 104 and 124 surrounding AP measurement unit, 105 and 126 beacon retention unit, 106 unused-channel detection unit, 107 reception power estimation unit, 108 carrier sensing estimation unit, 109 SINR calculation unit, 110 channel update trigger generation unit, 123 reconnection unit, 125 information notification unit.

1: A base station in a wireless system, the base station comprising:
a base station search unit that, when a predetermined condition is satisfied, instructs accommodated terminal stations to execute a base station search operation and searches for another base station;
a channel quality evaluation unit that evaluates quality of each of available wireless channels on a basis of a first search result, which is a result of a base station search by the base station search unit and a second search result, which is a result of a base station search by each of the accommodated terminal stations;
a channel selection unit that selects a wireless channel for use in communication with the accommodated terminal stations on a basis of a result of an evaluation by the channel quality evaluation unit; and
a channel switching unit that instructs the accommodated terminal stations to switch to a wireless channel selected by the channel selection unit for communication and switches a wireless channel for use by the base station to the wireless channel selected by the channel selection unit.

2: The base station according to claim 1, wherein
the channel quality evaluation unit determines presence or absence of a clear channel on a basis of the first search result and the second search result and, when no clear channel is present, calculates, for each wireless channel, an amount of influence by communication of another base station on communication within the wireless system and determines, for each wireless channel, whether or not communication opportunity of the base station is reduced by another base station performing communication, and
the channel selection unit selects a clear channel when a clear channel is present, and, when no clear channel is present, selects a wireless channel with which the amount of influence is equal to or less than a specified value and with which the amount of influence is a minimum out of wireless channels with which communication opportunity of the base station is not reduced by another base station performing communication.

3: The base station according to claim 2, wherein
the channel selection unit selects a wireless channel with which the amount of influence is a maximum when no clear channel is present and when the wireless channels with which communication opportunity of the base station is not reduced by another base station performing communication include no wireless channel with which the amount of influence is equal to or less than the specified value.

4: The base station according to claim 2, wherein
the channel selection unit selects a wireless channel identical to a wireless channel being used by another base station designated in advance by a user when no clear channel is present and when the wireless channels with which communication opportunity of the base station is not reduced by another base station performing communication include no wireless channel with which the amount of influence is equal to or less than the specified value.

5: The base station according to claim 2, wherein
the channel selection unit selects a wireless channel different from a wireless channel being used by another base station designated in advance by a user when no clear channel is present and when the wireless channels with which communication opportunity of the base station is not reduced by another base station performing communication include no wireless channel with which the amount of influence is equal to or less than the specified value.

6: The base station according to claim 1, wherein the channel switching unit instructs individually the accommodated terminal stations to switch to the wireless channel selected by the channel selection unit.

7: The base station according to claim 1, wherein the channel switching unit simultaneously instructs, by broadcasting, the accommodated terminal stations to switch to the wireless channel selected by the channel selection unit.

8: The base station according to claim 7, wherein the channel switching unit includes, in an instruction in the broadcasting, an instruction on timing to switch to the wireless channel selected by the channel selection unit.

9: The base station according to claim 8, wherein the channel switching unit provides the instruction in the broadcasting more than once at a certain interval and designates the timing to switch to the wireless channel selected by the channel selection unit by using the number of times the instruction in the broadcasting is provided.

10: The base station according to claim 9, wherein the channel switching unit switches a wireless channel for use to the wireless channel selected by the channel selection unit when the number of times the instruction in the broadcasting is provided reaches a specified number of times.

11: The base station according to claim 1, wherein the base station communicates with the terminal stations using a 2.4 GHz band.

12: A terminal station in a wireless system, the terminal station comprising:
a base station search unit that, when a base station to which the terminal station is connected instructs the terminal station to execute a base station search operation, searches for a base station to collect information on each nearby base station;
an information notification unit that notifies the base station to which the terminal station is connected of information collected by the base station search unit and information on power of a wireless signal transmitted by the terminal station as a base station search result and causes the base station to execute an operation to re-select a channel for use on a basis of the base station search result; and
a channel switching unit that, when a channel switching instruction is received from the base station to which the terminal station is connected, switches a wireless channel for use in communication with the base station to an indicated wireless channel.

13: A wireless communication system, comprising:
a base station in a wireless system, comprising
a base station search unit that, when a predetermined condition is satisfied, instructs accommodated terminal stations to execute a base station search operation and searches for another base station,
a channel quality evaluation unit that evaluates quality of each of available wireless channels on a basis of a first search result, which is a result of a base station search by the base station search unit and a second search result, which is a result of a base station search by each of the accommodated terminal stations,
a channel selection unit that selects a wireless channel for use in communication with the accommodated terminal stations on a basis of a result of an evaluation by the channel quality evaluation unit, and
a channel switching unit that instructs the accommodated terminal stations to switch to a wireless channel selected by the channel selection unit for communication and switches a wireless channel for use by the base station to the wireless channel selected by the channel selection unit, and
a terminal station in a wireless system, comprising
a base station search unit that, when a base station to which the terminal station is connected instructs the terminal station to execute a base station search operation, searches for a base station to collect information on each nearby base station,
an information notification unit that notifies the base station to which the terminal station is connected of information collected by the base station search unit and information on power of a wireless signal transmitted by the terminal station as a base station search result and causes the base station to execute an operation to re-select a channel for use on a basis of the base station search result, and
a channel switching unit that, when a channel switching instruction is received from the base station to which the terminal station is connected, switches a wireless channel for use in communication with the base station to an indicated wireless channel.
